(19) United States
(12) Patent Application Publication
(10) Pub. No.: US 2012/0311115 A1
(43) Pub. Date: Dec. 6, 2012

(54) ASSIGNMENT OF AGENT IDENTIFIER TO CLONED DEVICE

(76) Inventors: Paul Kennedy, San Mateo, CA (US); Matthew Duncan Hastie, La Jolla, CA (US)

(21) Appl. No.: 13/149,801

(22) Filed: May 31, 2011

(51) Int. Cl. G06F 15/177

(52) U.S. Cl. 709/222

(57) ABSTRACT

A method described herein provides for determining a cloned device has been cloned based on identifying information received from the clone device and stored information identifying the source device, and assigning a new agent identifier to the cloned device. Alternatively, a computer-readable medium may store instructions that, when executed, perform a method including determining a device has been cloned; copying static information and associating the copied static information with the cloned device; and generating and storing dynamic management information for the cloned device. Alternatively, an apparatus is provided to compare a received universally unique identifier (UUID) with a stored UUID associated with the agent identifier; determine that the cloned device was cloned when the received UUID is different than the stored UUID; and assign a new agent identifier to the cloned device.

### BACKGROUND

A managed server is a server whose full or partial lifecycle is managed by a software system at a management device, which may include creation/provisioning, day-to-day software, compliance management, deactivation and decommissioning. A managed server can be a physical or virtual server. In the most sophisticated software systems or management products, lifecycle management is performed via policy. A user of the system may declare policy settings in the software system which governs the is provisioning and day-to-day configuration of the server.

Physical servers can be duplicated or cloned. Once cloned, further actions may be performed to give the new physical server its own identity, i.e., assign it a unique machine identifier, etc., so that it has fully unique addressability in the management system.

### DRAWINGS

FIG. 1. is an example diagram of a source device, a cloned device and a management device in accordance with an example embodiment of the present disclosure.

FIG. 2 is an example flow diagram of steps for assigning a new agent identifier, in accordance with an example embodiment of the present disclosure.

FIG. 3 is another example flow diagram of steps for assigning a new agent identifier, in accordance with an example embodiment of the present disclosure, in accordance with an example disclosure.

FIG. 4 is an example flow diagram of steps for storing static and dynamic information, in accordance with an example embodiment of the present disclosure.

FIG. 5 is an example policy & configuration engine and model repository in accordance with an example embodiment of the present disclosure.

### DETAILED DESCRIPTION

Virtualization management products offer functionality for cloning of virtual servers. However, these products merely produce a cloned server that is essentially identical to the server from which it is generated. Virtualization management products may not complete the process in that the cloned server appears to the management device as a new device that needs to be registered with the management product in order for the cloned device to be managed by the management product.

Some cloning operations may be performed by a cloning application that is not associated with the management application at a management device. The agent on the newly cloned virtual machine may fail to identify when it was cloned. Thus, two agents on two different virtual machines, wherein one virtual machine, or template, is a source machine, and one virtual machine is a clone of the source machine, may report the same machine identification information, thus resulting in a software defect and a decrease in the level of manageability in a virtualized environment.

### Overview

As discussed herein, a source device may have included therein an agent that facilitates communication with a management application at a management device. The management device may manage the source device through communication the agent. The source device may have a machine identifier and an agent identifier. The agent identifier may be assigned by the management application.

When a cloning operation takes place, a cloned device may be created from the source device. During the cloning operation, the cloned device may receive a new machine identifier. However, in the cloning process, an agent identifier of the cloned device may be the same agent identifier of the source device, as it was copied during the cloning operation.

Upon communication with a management application at a management device, the cloned device may transmit to the management application indentifying information. This identifying information may include an agent identifier that it received during the cloning operation. This agent identifier may be the same agent identifier that was copied from the source device during the cloning operation. In addition, the cloned device may transmit to the management application a machine identifier that was assigned to the cloned device during the cloning operation. Since the cloned device is a different machine than the source device, the machine identifier of the source device may be different than the machine identifier of the cloned device.

Upon receiving the cloned device's identifying information at a management application, the management application may compare the received agent identifier and machine identifier of the cloned device with the machine identifier associated with the agent identifier and stored at the management device. While the agent identifier of the cloned device and the source device are the same, the machine identifier of the cloned device is different than the stored machine identifier of the source device. Thus, when the management application compares the received machine identifier with the stored machine identifier associated with the agent identifier, the stored machine identifier is different than the received machine identifier. Thus, the management application may determine that a cloning operation took place.

Once the management application determines that a cloning operation has taken place, the management application may assign a new agent identifier to the cloned device and register the cloned device with the newly assigned agent identifier. As the cloned device is essentially a copy of the source device, the cloned device may be managed based on management model data of the source device.

### Cloning

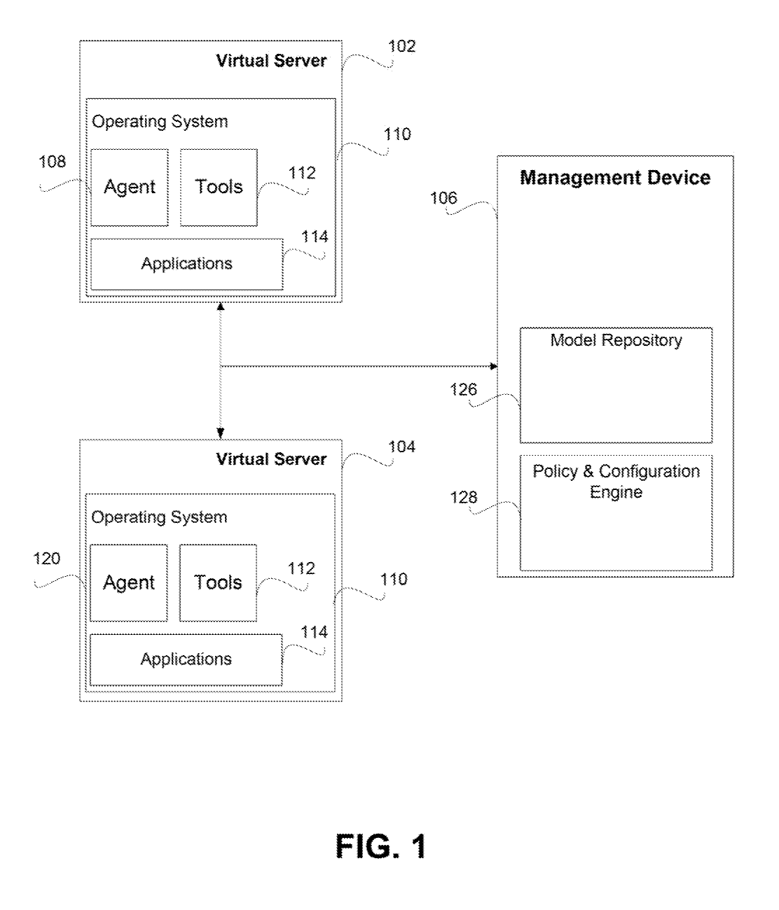

FIG. 1. depicts a diagram of a network including a source device 102, a cloned device 104 and a management device 106 in accordance with an example embodiment of the present disclosure. It may be appreciated that while only three devices are depicted in FIG. 1, other devices may reside within the network. Source device 102 and cloned device 104 may be, for example, virtual machines implemented in software including computer-readable instructions, executable by a processor and stored in a computer-readable storage medium. The virtual machines may reside on a physical machine that may be implemented through any suitable combinations of software including machine readable instructions, firmware, including machine readable instructions, and/or hardware. The physical machine may include, among other things, a central processing unit, memory, input/output devices, a networking application facilitate communication with other devices, both virtual and physical, within a network, other software applications.

Source device 102 may include operating system 110. Operating system 110 may include agent 108, for example, a server automation agent, tools 112, and applications 114. Agent 108 may facilitate communication with other devices within the network, including management device 106. Through agent 108, management device 106 may manage source device 102. Applications 114 may include software applications executable on source device 102 and may include, for example, Oracle 11i, IIS 7, .NET 3.5 and SharePoint 2007. Tools 112 may include, for example, VMware™ tools, and may facilitate management of the source device by management device 106.

When a cloning operation takes place, cloned device 104 maybe be created. At the time of cloning, software applications may be duplicated at cloned device 104. Thus, after the cloning operation, the cloned device may include, for example, operating system 110, applications 114 and tools 112. Applications 114 may include the software applications executable on cloned device 104 and copied from source device 102, for example, Oracle 11i, IIS 7, .NET 3.5 and SharePoint 2007. Tools 112 may include, for example, VMware™ tools, as copied from the source device and may facilitate management of the cloned device 104 by management device 106. Agent 108 of source machine 102 may be reinitialized as agent 120 at cloned device 104 at the time of clone to facilitate management of the cloned device 104.

Management device 106 may be implemented as, for example, a server device, a server automation core or analysis infrastructure, etc., and may be implemented through any suitable combinations of software including machine readable instructions, firmware, including machine readable instructions, and/or hardware. In addition, the functionality discussed herein may take place at one device, or may be distributed amongst multiple devices. Management device 106 may include a central processing unit, primary and secondary memory. Secondary memory may be implemented within management device 106 and/or may be implemented as external data storage. Primary and/or secondary memory may be computer-readable mediums configurable to store applications as discussed herein. Primary and/or secondary memory may further be configurable to receive an installation pack from an external memory, for example, a portable computer-readable medium, for example, a Compact Disc/Digital Video Disc, etc. Management device 106 may further include input/output devices and application(s) to facilitate communication with and management of devices 102, 104. Management device 106 may include a management application to facilitate communication with, registration of, and management of source device 102 and cloned device 104.

Management device 106 may further include model repository 126, which may be implemented as a data storage device that stores management model information of each managed device. A managed device may be any device that the management device may manage, for example, a source device, for example, a template, a virtual machine, etc., a cloned device, etc. For example, model repository 126 may store, for each managed device, management model data that may be used for managing the managed device. Management model data may include, for example, machine identification information, agent identification information, properties of the managed device, etc. A property may be a representation of a configuration in the management application where a configuration is a sequence of bits that reside on a managed device. Examples of properties may include a company operating the managed device, a data center associated with the managed device, information identifying software and version histories of the software installed on the managed device and information relating to a version of software installed on the managed device, metadata, information identifying groups the managed device is a member of, etc.

Management device 104 may further include policy & configuration engine 128. Policy & configuration engine may manage information stored in model repository 126. For example, policy & configuration engine 128 may access management model data, add, delete, or modify management model data, etc. In addition, policy & configuration engine 128 may determine a cloning operation has taken place based on information received from a cloned device, and may in coordination with model repository 126, generate and assign a new agent identifier to the cloned device, register the cloned device with model repository 126, and generate and store management model data for the cloned device in model repository 126.

It may be appreciated that while only two managed devices, source device 102 and cloned device 104 are depicted in FIG. 1, additional managed and unmanaged devices may reside in the network and may be communicable with management device 106.

### Determining Device is a Cloned Device

Upon boot up of a device, either a source device or a cloned device, the device may communicate with the management device 106. For example, the device may be an unmanaged cloned device. In other words, a cloning operation has taken place to create cloned device 104.

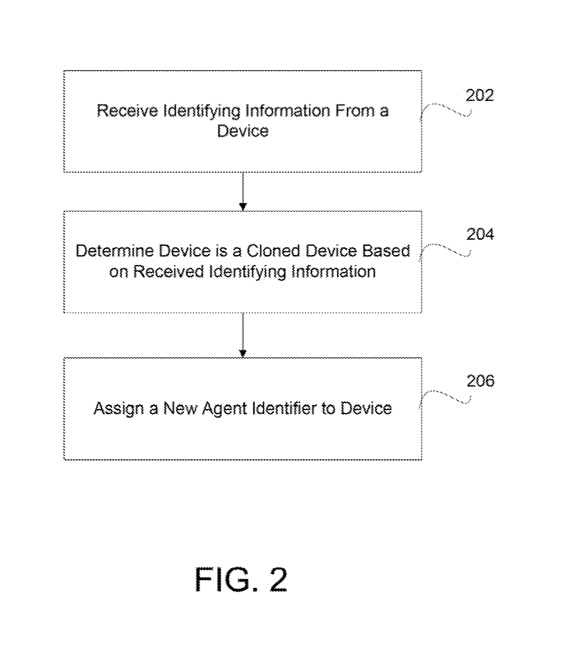

FIG. 2 depicts a diagram of the steps performed at the management device 106. As shown in FIG. 2, the management device 106 may receive identification information identifying the device (Step 202). This identification information may include an agent identifier of the device, a machine identifier of the device, etc. The management device 106 may access stored information associated with the device based on the received agent identifier.

The management device 106 may determine, based on the received identifying information of the device, that the device is a cloned device of a source device based on the received information (Step 204). For example, the management is device 106 may compare the received machine identifier with the stored machine identifier associated with the agent identifier. Where the received machine identifier is different than the stored machine identifier associated with the agent identifier, the management device 106 may determine that a cloning operation has taken place.

When the management device has determined that a cloning operation has taken place, the management device 106 may assign a new agent identifier for the cloned device (Step 206). This new agent identifier may permit the cloned device to be acknowledged by the management application as a separate, managed device.

The new agent identifier may be transmitted back to the device that sent the identifying information to the management device 106. The management device may initiate a reinitialization of the agent on the cloned device with the new agent identifier. During the reinitialization process, the management device may receive from the agent on the device information relating to software and hardware registration as discussed more fully below.

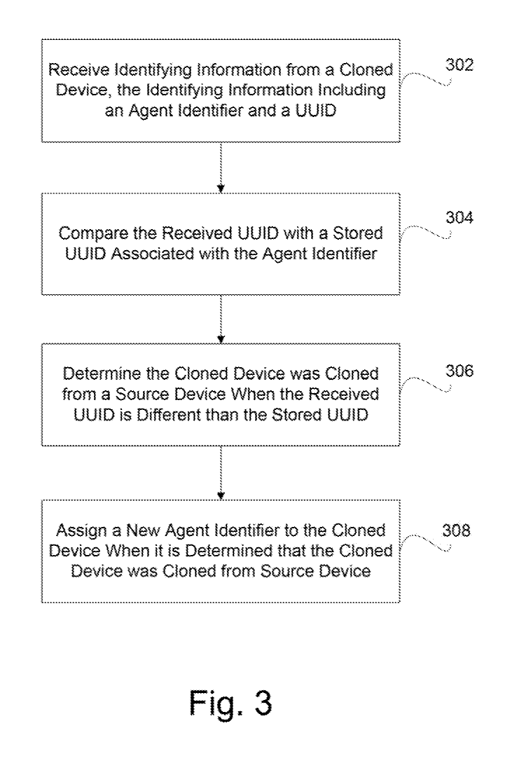

FIG. 3 depicts an alternate example of steps performed at the management device 106. As shown in FIG. 3, the management device 106 may receive identification information identifying a cloned device (Step 302). This identification information may include an agent identifier of the cloned device, a universally unique identifier (UUID), for example, a SMBIOS UUID machine identifier of the cloned device, etc. The management device 106 may access stored information associated the received agent identifier.

The management device 106 may compare the received UUID with a stored UUID associated with the agent identifier (Step 304). The management device may determine that the cloned device was cloned from a source device when the received UUID is different than the stored UUID (step 306). When the management device determines that the cloned device was cloned from the source device, the management device may assign a new agent identifier to the cloned device (Step 308).

Additional heuristics may be applied to determine the clone event, for example, the management device may communicate with the source machine to determine that it is indeed a device that is disparate to the clone. These additional heuristics may facilitate identification of the difference between a clone event from instances of a device UUID change, which may prevail in some datacenter environments.

The new agent identifier may be transmitted back to the cloned device that sent the identifying information to the management device 106. The management device may initiate a reinitialization of the agent on the cloned device with the new agent identifier. After the reinitialization process, the management device may receive from the agent on the cloned device information relating to software and hardware registration as discussed more fully below.

### Static and Dynamic Management Information

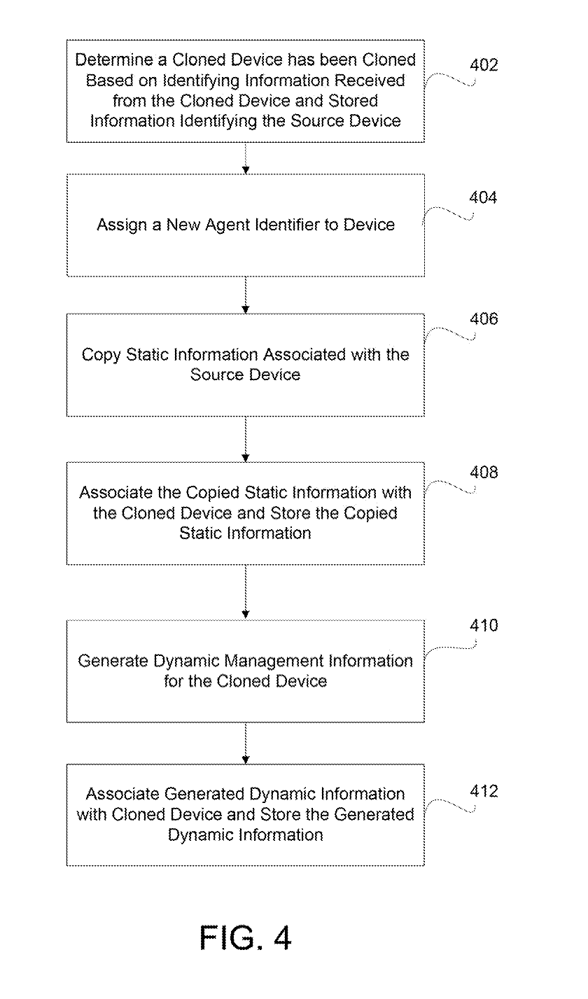

FIG. 4 depicts an example flow diagram of a method for storing dynamic and static management information. As can be seen in FIG. 4, the management device may determine that a cloned device has been cloned based on identifying information received from the cloned device and stored information identifying the source device (Step 402). This determination may be made, for example, as discussed with regard to FIG. 2, FIG. 3, etc. Once the management device determines that a cloning operation has taken place, a new agent identifier may be generated and assigned to the cloned device (404).

The management device may store management model information associated with the source device and use this management model information to manage the source device. Management model information may include information, for example, related to the software that is installed on the source device. As noted above, during a cloning operation, the source device may be copied to form a cloned device. For example, all software and associated data that resides on the source device is copied to the cloned device. The management device may copy static information associated with the source device (Step 406). Static information may represent management model information that may be used to manage both the source device and the cloned device. The information may be static since the same management model information may be used to manage the same software applications that are running on both the source and cloned devices. The copied static information may be associated with the cloned device and stored as management model information for the cloned device (step 408). For example, the management device may create a new record in the model repository and associate and store the copied static information with the new agent identifier assigned to the cloned device.

While the software may be copied from the source machine to the cloned device, it may be appreciated that the cloned device may have different hardware, hardware configuration, etc., than the source device. As such, certain management model information of the source device may not apply to management of the cloned device.

As noted above, the management device may initiate a reinitialization of the agent at the'cloned device with the newly assigned agent identifier. Upon reinitialization, the agent with the newly assigned agent identifier communicates with the management device. During this communication process, the management device may receive from the cloned device information relating to, for example, hardware, network configuration, hostname, hardware configuration, etc., of the cloned device. The management device 106 may generate dynamic management information for the cloned device (step 410). This generated dynamic management information may be based on the received information relating to, for example, the hardware, hardware configuration, network configuration, hostname etc., on the cloned device. This information may be considered dynamic management information as the management information changes based on, for example, the new hardware of the cloned device, the different characteristics between the source device and the cloned device, etc.

The generated dynamic information is associated with the cloned device and stored (step 412). For example, the generated dynamic information may be management information and may be associated with the newly assigned agent identifier of the cloned device. The cloned device may then be managed based on the copied static information and the generated dynamic information.

### Policy & Configuration Engine and Model Repository

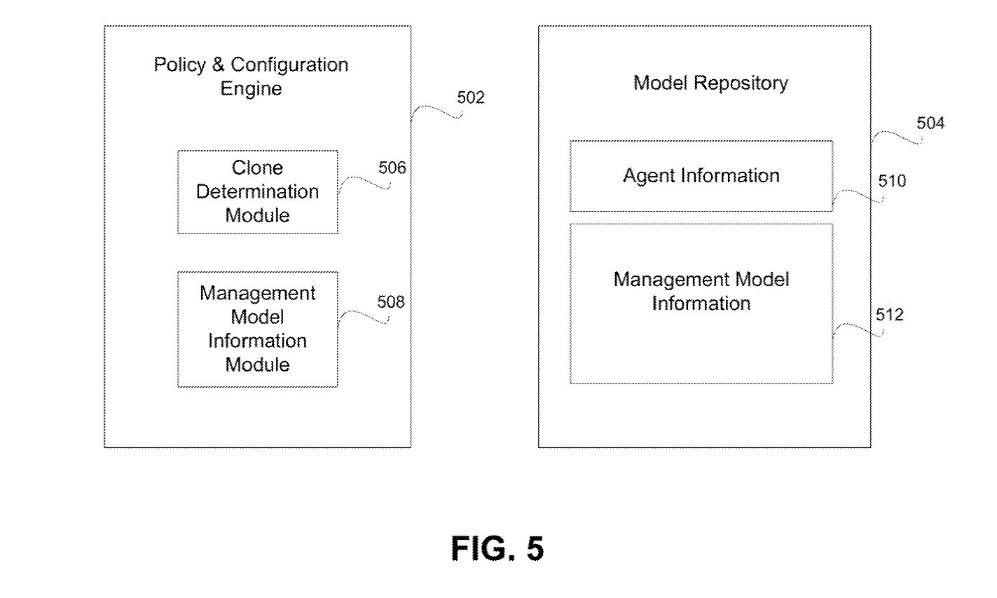

FIG. 5 is an example policy & configuration engine 502 and model repository 504 in accordance with an example embodiment. As shown in FIG. 5, policy & configuration engine 502 includes clone determination module 506. Clone determination module 506 determines, based on identifying information received from a device, for example, a cloned device, if a cloning operation has taken place. For example, when communicating with the cloned device 104, management device 106 may receive an agent identifier identifying agent 120 and a machine identifier. The agent identifier may be the same agent identifier that was cloned from the source device 102 during a cloning operation. The machine identifier may a unique identifier, for example, SMBIOS UUID, that it received during the cloning operation. The machine identifier may be different than the machine identifier of the source device 102.

Agent information 510 stores information regarding managed devices. For example, for each managed device in the network, agent information 510 may store the agent identifier of an agent, as assigned by the management device, and, associated therewith, may store the machine identifier, for example, the UUID, of the machine the agent resides on.

Upon receipt of the agent identifier and the machine identifier from the cloned device, clone determination module 506 may access agent information 510 at model repository 504. Clone determination module 506 may query agent information 510 for the stored machine identifier that is associated with the agent identifier received from the cloned device. Clone determination module may then compare the stored machine identifier with the machine identifier received from the cloned device. If the received machine identifier is not the same as the stored machine identifier associated with the agent identifier, clone determination module 506 may determine a cloning operation has taken place. Specifically, clone determination module 506 may determine that the cloned device was cloned from the source device having the stored agent identifier.

Clone determination module 506 may then, in conjunction with model repository 504, assign a new agent identifier to the agent of the cloned device, and store the received machine identifier with the new agent identifier in agent information 510. This new agent identifier may be transmitted back to the cloned device. The clone determination module 506 may then initiate a reinitialization of the cloned device with the new agent identifier.

Once the cloned agent reinitializes with the new agent identifier, the cloned device transmits software and hardware registration information to the policy & configuration engine. This software and hardware registration information may be used to generate dynamic management information.

Once the new agent identifier is assigned to the cloned device, management model information module 508 may create a new record for the agent of the cloned device, including the new agent identifier. As the clone determination module 506 has determined that the cloned device was cloned from a source device, and the cloned device is created from the source device, any management model information that was used to manage the copied components of the source device may be used to manage the corresponding copied components of the cloned device. The management model information that corresponds to components that were copied to the cloned device may be considered static management information.

Upon creation of the record in the management model information 512, the static management information associated with the agent identifier of the source device may be copied and stored in association with the new agent identifier of the cloned device.

While a cloned device may be similar to the source device in light of the information copied from the source device, the cloned device may be different from the source device, for example, in hardware configuration, IP address, etc. Thus, the management model information module 508 may generate dynamic management information based on information it receives from the cloned device relating to software and hardware registration. For example, upon receiving the IP address from the cloned device, the management model information module 508 may calculate management model information that is dependent on IP addresses, i.e., what group(s) the cloned device may belong to, any other value that can be applied as input to the clone process, etc. The generated dynamic management information may then be stored in association with the new agent identifier and stored in management model information 512 at model repository 504.

The cloned device may then be managed by the management device based on the static and dynamic management model information associated with the new agent identifier.

I claim:

1. A method, comprising:
receiving identifying information from a cloned device;
determining the cloned device has been cloned from a source device based on the identifying information received from the cloned device and stored information identifying the source device; and
assigning a new agent identifier to the cloned device.

2. The method of claim 1, further comprising:
generating and storing management information for the cloned device.

3. The method of claim 2, wherein generating management information includes:
storing static management information of the source device as management information of the cloned device;
generating dynamic management information for the cloned device;
associating the generated dynamic information with the cloned device; and
storing the generated dynamic information.

4. The method of claim 3, wherein generating dynamic management information includes:
determining hardware properties of the cloned device; and
calculating dynamic management information based on the determined hardware properties of the cloned device.

5. The method of claim 3, further comprising:
managing the cloned device based on the static and dynamic management information associated with the cloned device.

6. The method of claim 1, wherein the identifying information received from the cloned device includes a machine identifier and an agent identifier and wherein the stored information identifying the source device includes a machine identifier.

7. The method of claim 6, further comprising:
comparing the received machine identifier of the cloned device with the stored machine identifier associated with the received machine identifier; and
determining that the cloned device has been cloned when the received machine identifier is different than the stored machine identifier.

8. The method of claim 6, wherein the received machine identifier of the cloned device and the stored machine identifier are a universally unique identifier (UUID).

9. A non-transitory computer-readable medium, storing a set of instructions, executable by a processor, to perform a method comprising:
determining a cloned device has been cloned from a source device based on identifying information received from the cloned device and stored information identifying the source device;
assigning a new agent identifier to the cloned device;
copying static management information associated with the source device;
associating the copied static management information with the cloned device and storing the copied static management information;
generating dynamic management information for the cloned device;
associating the generated dynamic management information with the cloned device; and
storing the generated dynamic management information.

10. The non-transitory computer-readable medium of claim 9, wherein the identifying information received from the cloned device includes a machine identifier and an agent identifier and wherein the stored information identifying the source device includes a machine identifier.

11. The non-transitory computer-readable medium of claim 10, wherein determining a cloned device has been cloned from a source device includes:
comparing the received machine identifier of the cloned device with the stored machine identifier associated with the received machine identifier; and
determining that the cloned device has been cloned when the received machine identifier is different than the stored machine identifier.

12. The non-transitory computer-readable medium of claim 11, wherein the received machine identifier of the cloned device and the machine identifier of the source device is a universally unique identifier (UUID).

13. The non-transitory computer-readable medium of claim 9, the method further comprising:
initiating a reinitialization of the agent at the cloned device with the new agent identifier.

14. An apparatus having a memory storing a set of processor-executable instructions, and a processor to execute the stored instructions that, when executed, cause the processor to:
receive identifying information from a cloned device, the identifying information including an agent identifier and a universally unique identifier (UUID);
compare the received UUID with a stored UUID associated with the agent identifier;
determine that the cloned device was cloned from a source device when the received UUID is different than the stored UUID; and
assign a new agent identifier to the cloned device when it is determined that the cloned device was cloned from the source device.

15. The apparatus of claim 14, wherein the memory stores instructions that, when executed, cause the processor to further:
initiate a reinitialization of the cloned agent with the new agent identifier;
receive a communication from the cloned device, the communication including the new agent identifier; and
manage the cloned device based on the received new agent identifier.

16. The apparatus of claim 15, wherein the memory stores instructions that, when executed, cause the processor further to:
after initiation of the reinitialization of the cloned agent, receive information relating to software registration and hardware registration of the cloned device.

17. The apparatus of claim 16, wherein the memory stores instructions that, when executed, cause the processor further to:
generate dynamic management information for the cloned device based on the information relating to the hardware registration received from the cloned device;
associate the generated dynamic information with the new agent identifier of the cloned device; and
store the generated dynamic management information.

18. The apparatus of claim 14, wherein the memory stores instructions that, when executed, cause the processor to further:
copy static information associated with the source device;
associate the copied static information with the cloned device and store the copied static information;
generate dynamic management information for the cloned device;
associate the generated dynamic information with the cloned device; and
store the generated dynamic information.

19. The apparatus of claim 18, wherein the memory stores instructions that, when executed, cause the processor to further:
receive hardware properties of the cloned device, wherein the dynamic management information is generated based on the received hardware properties of the cloned device.

20. The apparatus of claim 18, wherein the memory stores instructions that, when executed, cause the processor to further:
manage the cloned device based on the copied static information and the generated dynamic management information.
